(19) United States
(12) Patent Application Publication
(10) Pub. No.: US 2024/0215498 A1
(43) Pub. Date: Jul. 4, 2024

(54) SYSTEM FOR CONTROLLING ROOT ZONE TEMPERATURE

(71) Applicant: PHENOROOT LTD., Rehovot (IL)

(72) Inventor: Gadi PELEG, Kibbutz Gal'on (IL)

(21) Appl. No.: 18/289,135

(22) PCT Filed: Apr. 26, 2022
(86) PCT No.: PCT/IL2022/050424

§ 371 Date: Nov. 1, 2023

Related U.S. Application Data
(60) Provisional application No. 63/184,927, filed on May 6, 2021.

(51) Int. Cl. A01G 9/24

(52) U.S. Cl. CPC A01G 9/246; A01G 9/245

(57) ABSTRACT

Provided herein are systems and methods for controlling temperature of root zone of plants, by providing gas at controlled temperature to root zone region of plants, wherein the root zone is at least partially isolated from above ground plant parts, and wherein the temperature controlled gas is provided above ground.

### FIELD OF INVENTION

This present disclosure relates to systems and methods for affecting or controlling plants root zone temperature, to thereby improve root and plant health and growth.

### BACKGROUND OF THE INVENTION

Plant parts include the root system, which is underground while above ground plant parts include the stem, leaves flowers and fruits. The above ground plant parts and the roots are each exposed to different environment, meaning that each of the parts may require different optimal conditions for growth and health.

The growth of plants is affected by various environmental and physiological conditions, including, for example, light, nutrients, water, soil and temperature.

The temperature of the roots can affect various factors of the plant growth and accordingly, maintaining, affecting or controlling the root zone temperature is highly important for the plant growth, health and yield.

Thus, there is a need in the art for systems and methods that allow controlling temperature of plants root zone in an efficient and cost effective manner, to thereby improve root health and plant growth and yield.

### SUMMARY OF THE INVENTION

According to some embodiments, provided herein are systems and methods for controlling or affecting root zone temperature of plants, wherein the root zone is at least partially thermally isolated from other plant parts and wherein the temperature is controlled by dispensing gas at a suitable temperature, above ground, in close proximity to the at least partially thermally isolated root zone region, to thereby provide the most suitable and effective conditions to the plant in general and the root zone in particular.

According to some embodiments, the systems and methods disclosed herein are advantageous as they allow controlling the temperature of the root zone of plants in an accurate, safe, energy efficient and cost effective manner. In particular, the systems and methods disclosed herein do not interact or disturb the underground soil/substrate in which the roots reside, and thereby do not physically and directly affect, interfere, disturb or otherwise harm the roots themselves. By utilizing the advantageous above ground temperature control system as currently disclosed, a suitable and customized microenvironment is created for root zone of plants, which ultimately improves the root condition and hence the plant health, growth and yield. Moreover, the systems and methods disclosed herein are further advantageous, as they allow providing a separate microenvironment for the root zone and other above ground plant parts, which mimics the natural environment of the plant, whereby the roots and the aerial plant parts each grow under different environmental conditions (such as, temperature, light, humidity, and the like).

According to some embodiments, the systems disclosed herein are further advantageous as they can be suitable for a wide range of plants grown in various conditions and under versatile settings. In some embodiments, the systems disclosed herein can be effectively used for pot plants (i.e., plants grown in pots) and/or for field crops (i.e., plants grown in the field).

According to some embodiments, the systems and methods disclosed here can also be utilized as a research tool for plants under extreme temperature conditions. The method and system can facilitate selecting the best root system for development under extreme temperatures.

In further embodiments, the systems and method disclosed herein are configured to provide optimal temperature conditions for root zone of various types of plants, at various growth settings, by circulating air at controlled temperature in close proximity to the at least partially thermally isolated root zone of plants, in a closed circuit manner.

According to some embodiments, there is thus provided a system for controlling temperature of root zone of plants, the system includes:
one or more separating elements configured to at least partially thermally isolate root zone of a plant from other above ground plant parts;
an air condition unit configured to provide gas at a required temperature;
one or more dispensing conduits configured to transfer the gas provided by the air condition unit and dispense said gas above ground in close proximity to the at least partially isolated root zone; and
one or more return conduits configured to return at least a portion of the dispensed gas to the air condition unit.

According to some embodiments, the separating element is a continuous element configured to allow at least partial thermal isolation of a plurality of plants.

According to some embodiments, each plant is fitted with an individual separating element.

In some embodiments, each plant root is at least partially thermally isolated.

According to some embodiments, the separating element may be selected from, but not limited to: a cover, a sheet, a container, a box, and the like, or any combinations thereof.

According to some embodiments, the separating element may be made of at least partially isolating material. In some embodiments, the at least partially isolating material may be made of any suitable material, such as, but not limited to: plastic, cellulose, polystyrene, extruded polystyrene foam, expanded polystyrene foam, fiberglass, and the like, or combinations thereof.

In some embodiments, the separating element may be transparent or semi-transparent.

According to some embodiments, the separating element may include an opening/aperture traversing the upper face thereof. In some embodiments, the opening is configured to allow the passage of the above ground plant part therethrough.

According to some embodiments, the size of the opening may be predetermined or may be adjustable according to the size of the plant/plant part.

According to some embodiments, the above ground plant parts may include any above ground part of the plant, such as, for example, stem, leaf, flower, fruit, or any combinations thereof.

According to some embodiments, the gas may include any suitable gashouse fluid, such as, air (such as atmospheric air), CO₂, nitrogen, or combinations thereof.

According to some embodiments, the dispensed gas may further include gas one or more volatile substances, that may be mixed with the gas, or dispensed concomitantly with the gas.

In some embodiments, the volatile substances may include any suitable anti-plant pathogen substance, such as, anti-fungal substances and/or anti-pests substances.

According to some embodiments, the conduits may be in the form of pipes or tubes. The dispensing conduits and the return conduits may identical, similar or different with respect of size (length, diameter), shape, and/or composition.

According to some embodiments, the dispensing conduits may include dispensing openings/outlets/apertures along their length, wherein the openings are configured to allow dispensing of the gas to or towards the root zone.

According to some embodiments, the dispensing openings may be positioned so as to dispense gas in the direction of the root zone (for example, downwards or sideways).

According to some embodiments, the dispensing conduits may further include a second set of dispensing openings configured to dispense gas in the direction of the separating element (for example, upwards). In some embodiments, the second set of the dispensing openings is configured to dispense gas in the direction of the opening of the separating element.

According to some embodiments, the system may further include one or more blowers configured to transfer air from the air condition unit via the dispensing conduits. In some embodiments, the system may include one or more pumps configured to pump air towards the air condition unit via the return conduits.

According to some embodiments the gas is circulated. In some embodiments, the gas is circulated such that the gas dispensed at the requested temperature via the dispensing conduits is returned to the air condition unit via the return conduits.

According to some embodiments, the system may further include a control unit, a display, a communication unit, or any combinations thereof.

According to some embodiments, the system may further include one or more temperature sensors configured to sense the temperature at least at a region in close proximity to the root zone of the plants. In some embodiments, the one or more temperature sensors may be configured to sense temperature at one or more additional regions, such as, for example, in ground, at the plant stem region, at the plant leaf region, at the plant flower region, and the like, or any combinations thereof.

According to some embodiments, the required temperature of the gas is determined manually or automatically.

According to some embodiments, the temperature of the dispensed gas may be determined or adjusted based on the sensed temperature at the region of the root zone.

According to some embodiments, the gas may be provided at a temperature in the range of about −10 (minus 10 degrees Celsius) to about +50° C.

According to some embodiments, the system disclosed herein may be used in a method of controlling the temperature of root zone of plant.

According to some embodiments, there is provided a method of controlling temperature of root zone of a plant, the method includes:
at least partially isolating the root zone of the plant from other above ground plant parts;
providing gas at a desired temperature to the root zone, wherein the gas is provided above ground; and
circulating the gas, to thereby control the temperature of the root zone.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale.

In the figures:

FIG. 1 is a schematic illustration of a system for controlling root zone temperature of pot plants, according to some embodiments;

FIG. 2 is a schematic illustration of a system for controlling root zone temperature of field plants, according to some embodiments;

FIG. 3 is a schematic close-up view of gas conduits and separating element of a system, according to some embodiments; and

FIG. 4 is a pictogram of plant harbored in a separating element, according to some embodiments.

### DETAILED DESCRIPTION OF THE INVENTION

The following is a detailed description of the invention provided to aid those skilled in the art in practicing the present invention. Those of ordinary skill in the art may make modifications and variations in the embodiments described herein without departing from the spirit or scope of the present invention.

The present invention provides system and method for controlling temperature of root zone of plants, by providing gas at controlled temperature to root zone region of plants, wherein the root zone is at least partially isolated from other above ground plant parts, and wherein the temperature controlled gas is provided above ground.

According to some embodiments, the system may include one or more separating elements configured to at least partially thermally isolate root zone of a plant from other above ground plant parts; an air condition unit configured to provide gas at a required temperature; one or more dispensing conduits configured to transfer the gas provided by the air condition unit and dispense said gas above ground in close proximity to the at least partially isolated root zone; and one or more return conduits configured to return at least a portion of the dispensed gas to the air condition unit.

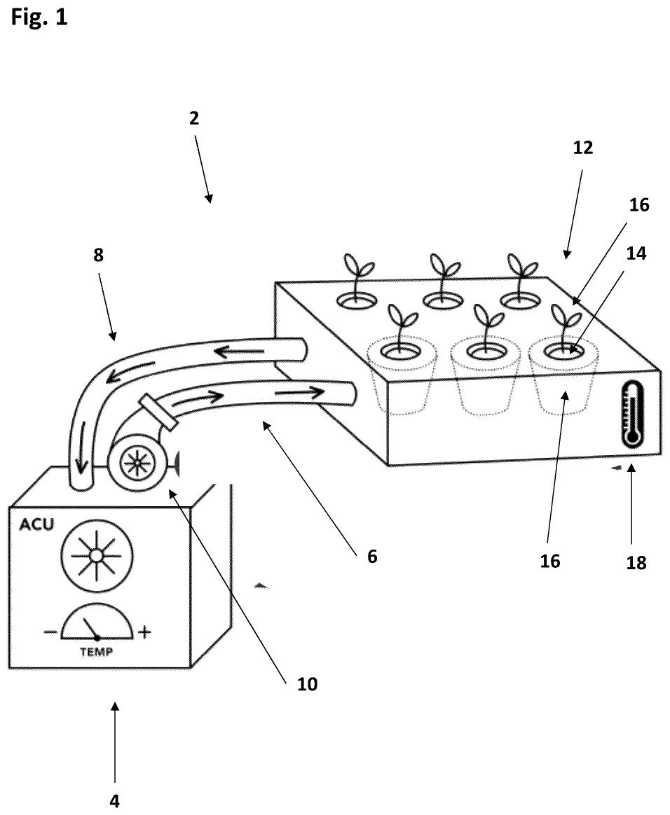

Reference is now made to FIG. 1, which is a schematic illustration of a system for controlling root zone temperature of pot plants, according to some embodiments. As shown in FIG. 1, system 2 for controlling root zone temperature includes an air condition unit 4, which is configured to provide gas at a controlled temperature, as determined by a user (or automatically determined), for example, based on the ambient conditions, type of plant, growing conditions, and the like. System 2 further includes dispensing conduits 6, which are configured to transfer the gas (in some embodiments, with a blower, such as blower 10 from the air condition unit 4 towards the plants, and more particularly, towards the root zone portion of the plants. The root zone is separated and at least partially thermally isolated from above ground plant parts (aerial parts) (represented by aerial plant part 16 in FIG. 1) by separating element 12. Separating element 12 is made of at least partially isolating material, as detailed above. Separating element 12 includes at an upper face thereof an opening 16, through which the above ground plant parts protrude. In some embodiments, separating element is a continuous element. In some embodiments, each plant has a corresponding opening in the separating element. In some embodiments, the size and/or shape of the opening may be adjustable or predetermined. In some embodiments, each plant has an individual separating element. In some embodiments, the separating element may be in any suitable shape, size and form, to allow it to at least partially thermally isolate the root zone of the plant. The gas dispensed to the root zone is dispensed above ground, in close proximity to the root zone, thereby providing a suitable temperature controlled environment to the at least partially isolated root zone. The dispensed gas may be recirculated and returned to the air condition unit 4 via return conduits 8. The returning of the gas may be facilitated by corresponding pumps. Thus, in some embodiments, the gas may be dispensed and returned in a closed circulation. In some embodiments, the gas may be air (such as atmospheric air). In some embodiments, the gas may be any type of gas, such as, CO₂, nitrogen, or any mix/enrichment of air with other gasses). In some embodiments, the gas may be air enriched with various other gasses. In some embodiments, the gas may further include volatile substances, such as, pesticides, antifungal, or any other anti-pests substances. As further shown in FIG. 1, the system may further include one or more temperature sensors (such as exemplary sensor 18) that may be used to sense temperature at various regions, such as, for example, in close proximity to the root zone. The temperature sensor may further convey information to the air condition unit (for example, to a control module of the air condition unit, via, for example, a communication unit), to allow controlling or adjusting the operation of the air condition, so as to maintain a suitable required temperature at the root zone.

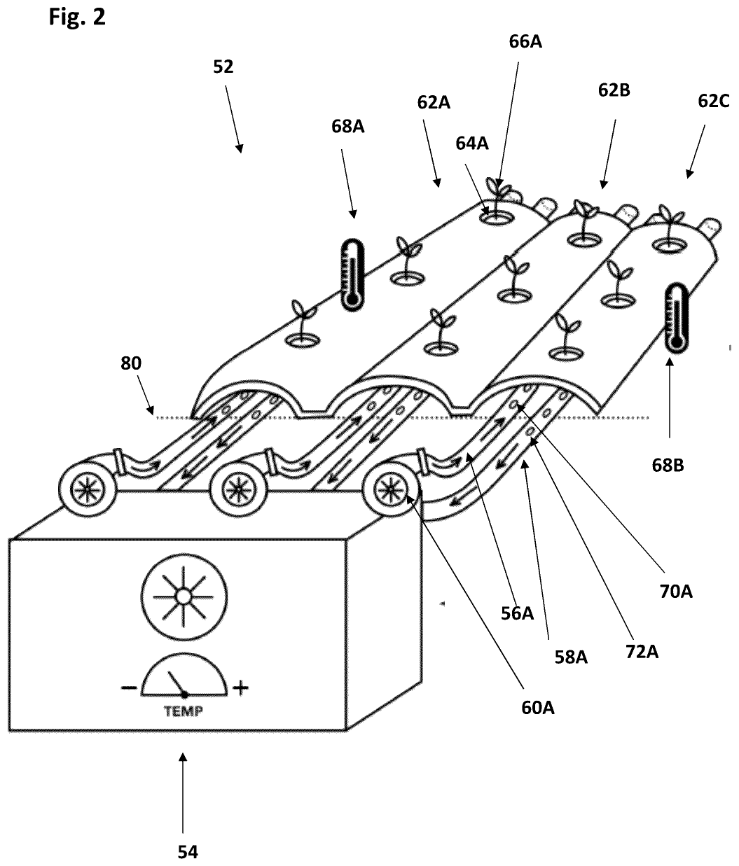

Reference is now made to FIG. 2, which is a schematic illustration of a system for controlling root zone temperature of field plants, according to some embodiments. As shown in FIG. 2, system 52 for controlling root zone temperature includes an air condition unit 54, which is configured to provide gas at a controlled temperature, as determined by a user (or automatically determined), for example, based on the ambient conditions, type of plant, growing conditions, and the like. System 2 further includes dispensing conduits (shown as exemplary conduit 56A), which are configured to transfer the gas (in some embodiments, facilitated by a blower, such as blower 60A) from the air condition unit 54 towards the plants, and more particularly, towards the root zone of the plants. The root zone is separated and at least partially thermally isolated from above ground plant parts (aerial parts) (represented by aerial plant part 66A in FIG. 2) by separating elements, such as exemplary separating element 62A-C. Separating elements 62A-C may be made of at least partially isolating material, as detailed above. The separating elements 62A-C may be one unit having various regions, may be made of interconnected separating units, or may be each physically separated. The separating elements may include at an upper surface thereof openings, for the aerial plant parts). For example, separating element 62A include at an upper face thereof, openings (such as exemplary opening 64A), through which the above ground plant parts can protrude. In some embodiments, the separating elements are a continuous element. In some embodiments, each plant has a corresponding opening in the separating element. In some embodiments, the size and/or shape of the opening may be adjustable or predetermined. In some embodiments, each plant or each group of plants may have an individual separating element. In some embodiments, the separating element may be in any suitable shape, size and form, to allow it to at least partially thermally isolate the root zone of the plant, such as, in the shape of a cover, sheet, box, and the like. The gas dispensed to the root zone is dispensed above ground (represented by line 80), in close proximity to the root zone, thereby providing a suitable temperature controlled environment to the at least partially isolated root zone. The gas may be dispensed via suitable openings placed along the length of the dispensing conduits (shown as exemplary opening 70A). The dispensed gas may be recirculated and returned to the air condition unit 54 via return conduits, such as exemplary return conduit 58A, which may also include dispensing openings (such as exemplary opening 72A). The returning of the gas may be facilitated by corresponding pumps. Thus, in some embodiments, the gas may be dispensed and returned in a closed circulation. In some embodiments, the gas may be air (such as atmospheric air). In some embodiments, the gas may be any type of gas, such as, CO₂ or nitrogen. In some embodiments, the gas may be air enriched with various other gasses. In some embodiments, the gas may further include volatile substances, such as, pesticides, antifungal, or any other anti-pests substances. As further shown in FIG. 2, the system may further include one or more temperature sensors (such as exemplary sensors 68A-B) that may be used to sense temperature at various regions, such as, for example, in close proximity to the root zone. The temperature sensor may further convey information to the air condition unit (for example, to a control module of the air condition unit, via, for example, a communication unit), to allow controlling or adjusting the operation of the air condition, so as to maintain a suitable required temperature at the root zone.

As shown in FIG. 2, the system for controlling root zone temperature may be fitted to any setting of plants growth, regardless of the type of crop (for example, pot or field), size of crop, size of plants, and the like.

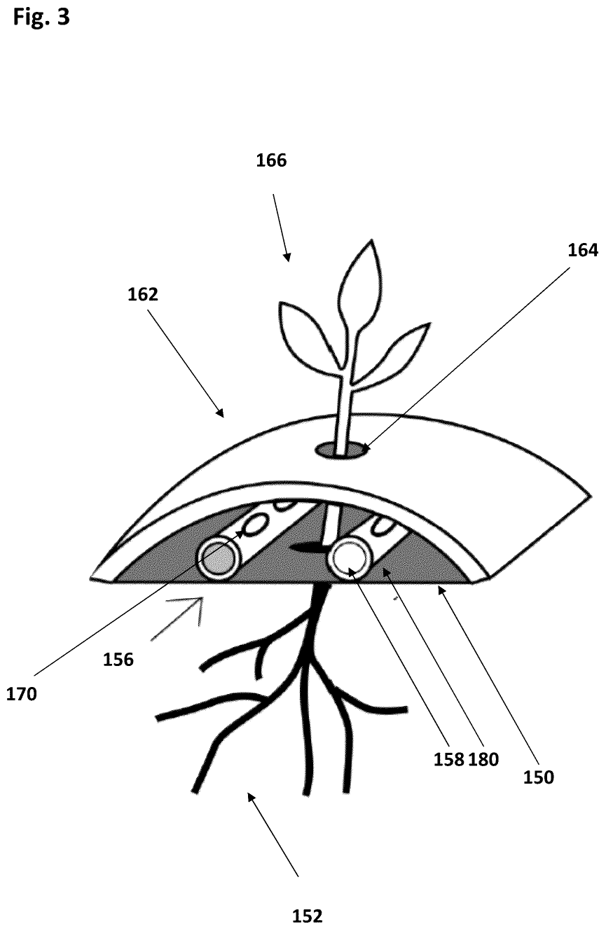

Reference is now made to FIG. 3, which is a schematic close-up view of gas conduits and separating element of a system, according to some embodiments. As shown in FIG. 3, separating element 162, which is in a form of a sheet or cover, at least partially thermally isolate the root zone 180 of root 152, from the aerial parts 166 of the plant. The separating element includes an opening/aperture 164 at an upper face thereof, which allows the above ground part of the plant to pass therethrough. The location, position, size and/or shape of the opening may be adjustable or predetermined, based, for example, on the size and/or type of the plant. Further shown in FIG. 3 is dispensing conduit 156, which is placed above ground (represented by line 150). The dispensing conduit 156 includes dispensing openings/apertures along its length (such as exemplary dispensing opening 170. The size, shape, location and/or direction of the dispensing opening may be adjusted or predetermined. In some embodiments, the location of the dispensing openings may be such that the openings direct the dispensed gas towards the root zone for example, downward or sideways). In some embodiments, additional openings may be present on the conduit, which may be directed upward towards the upper region of the plant. Further shown in FIG. 3 is return conduit 158, which is configured to allow the gas to return to the gas supplier (i.e., air condition unit), for example, by at least partially circulating the gas, for example, in a closed loop (i.e., the dispensing conduit and the retune conduit may be connected at their distal end, to from a close loop). As detailed above, the return conduit may further include openings along its length.

In some embodiments, the conduits may be any type of suitable tubes, pipes, channels and the like. In some embodiments, the size (length, diameter), shape and/or composition of the various conduits may be similar, identical or different. In some embodiments, the size, location, position, number and/or distribution of the various dispensing openings may be similar, different or identical between various conduits.

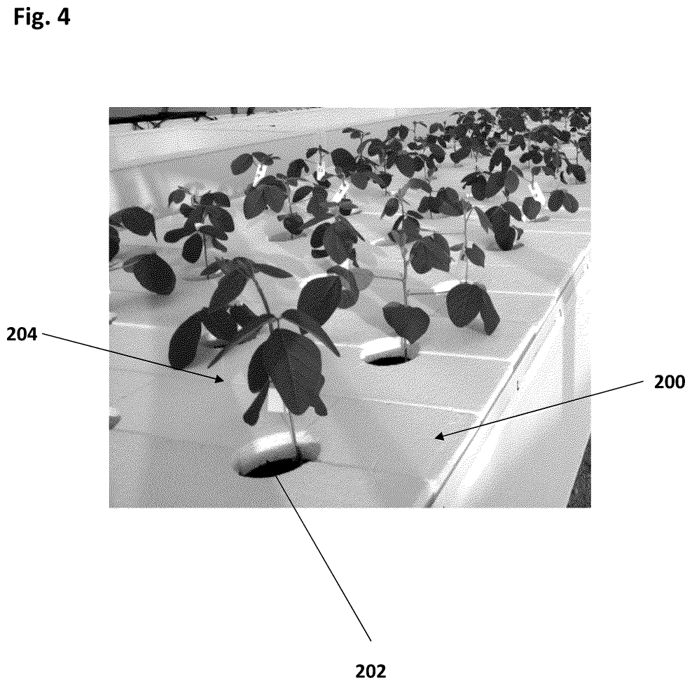

Reference is now made to FIG. 4, which is a pictogram of plant harbored in a separating element, according to some embodiments. As shown in FIG. 4, aerial parts of plants (exemplary plant 204 is shown) protrude via corresponding opening (exemplary opening 202) in a separating element (200). The separating element 200 shown in FIG. 4 is in a form of a box, which is configured to at least partially thermally isolate the corresponding root zone of the plant, to allow creating or maintaining temperature controlled environment for the root zone. As demonstrated in FIG. 4, each plant of the plurality of plants has a corresponding opening in the separating element.

In some embodiments, the root zone temperature control (RZT) may be also passively controlled (alternatively to or in addition to the gas dispensing), by using insulation materials having different transparency properties. By using permeable/impermeable/semi-permeable materials/transparent/semi-transparent-nontransparent material, the amount of radiation (from the sun) enters the isolated root zone can be controlled. For example, colder RZT can be achieved by preventing radiation (in summer) and warmer RZT can be achieved by radiation that heating of the pots/soil/root-zone.

In the description and claims of the application, the words “include” and “have”, and forms thereof, are not limited to members in a list with which the words may be associated.

As used herein, the term “about” may be used to specify a value of a quantity or parameter (e.g., the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

1.-24. (canceled)

25. A system for controlling temperature of root zone of plants, the system comprising:
one or more separating elements configured to at least partially thermally isolate root zone of a plant from other above ground plant parts;
an air condition unit configured to provide gas at a required temperature;
one or more dispensing conduits configured to transfer the gas provided by the air condition unit and dispense said gas above ground in close proximity to the at least partially isolated root zone;
one or more return conduits configured to return at least a portion of the dispensed gas to the air condition unit;
to thereby control temperature of the root zone.

26. The system according to claim 25, wherein the separating element is a continuous element configured to allow at least partial thermal isolation of a plurality of plants.

27. The system according to claim 25, wherein each plant is fitted with an individual separating element.

28. The system according to claim 25, wherein the separating element comprises a cover, a sheet, a container, a box, or any combinations thereof.

29. The system according to claim 25, wherein the separating element is made of at least partially isolating material, selected from, plastic, cellulose, polystyrene, extruded polystyrene foam, expanded polystyrene foam, fiberglass, or combinations thereof.

30. The system according to claim 25, wherein the separating element comprises an opening traversing the upper face thereof, said opening configured to allow the passage of the above ground plant part therethrough.

31. The system according to claim 30, wherein the size of the opening is adjustable according to the size of the plant.

32. The system according to claim 25, wherein the above ground plant parts comprise: stem, leaf, flower, fruit, or combinations thereof.

33. The system according to claim 25, wherein the gas comprises air, CO₂, nitrogen, or combinations thereof.

34. The system according to claim 25, wherein the gas further comprises one or more volatile substances.

35. The system according to claim 34, wherein the volatile substances comprise anti-fungal substances and/or anti-pest substances.

36. The system according to claim 25, wherein the dispensing conduits comprises dispensing openings along their length, said openings configured to allow dispensing of gas to the root zone.

37. The system according to claim 36, wherein the dispensing openings are positioned so as to dispense gas in the direction of the root zone.

38. The system according to claim 36, wherein the dispensing conduits further comprises a second set of dispensing openings configured to dispense gas in the direction of the separating element.

39. The system according to claim 25, further comprising one or more blowers configured to transfer air from the air condition unit via the dispensing conduits, and/or one or more pumps configured to pump air to the air condition unit via the return conduits.

40. The system according to claim 25, wherein the gas is circulated.

41. The system according to any claim 25, further comprising one or more temperature sensors configured to sense the temperature at least at the root zone region of the plants.

42. The system according to claim 25, wherein the required temperature of the gas is determined manually or automatically.

43. The system according to claim 25, configured to provide gas at a temperature in the range of about 0-50° C.

44. A method of controlling temperature of root zone of a plant, the method comprising:
at least partially isolating the root zone of the plant from other above ground plant parts;
providing gas at a desired temperature to the root zone, wherein the gas is provided above ground; and
circulating the gas, to thereby control the temperature of the root zone.
